(19) United States
(12) Patent Application Publication
(10) Pub. No.: US 2005/0203748 A1
(43) Pub. Date: Sep. 15, 2005

(54) System and method for presenting and browsing information

(76) Inventors: Anthony Levas, Yorktown Heights, NY (US); Chalapathy Neti, Yorktown Heights, NY (US); Joseph R. Branc, Grand Rapids, MI (US); Terence Douglas West, Caledonia, MI (US)

Correspondence Address: DILWORTH & BARRESE, LLP, 333 EARLE OVINGTON BLVD., UNIONDALE, NY, 11553, US

(21) Appl. No.: 10/797,847

(22) Filed: Mar. 10, 2004

(51) Int. Cl. G06F 7/00

(52) U.S. Cl. 704/275

(57) ABSTRACT

Disclosed is a system and method for presenting and browsing information, comprising the steps of classifying the information into a plurality of classes and sub-classes, each class having at least one sub-class; and presenting the plurality of classes of information to a user. The a system and method capable of interactively controlling the presentation of the sub-classes.

### FIELD OF THE INVENTION

The present invention relates to a system and method for presenting and browsing information.

### BACKGROUND OF THE INVENTION

Visually impaired people or those that temporarily do not have the ability to “look” at a text, for example due to lighting conditions or requirements of a task being performed, e.g., driving, today can “read” or perceive a textual document by using “variable speed” Text-To-Speech translating devices. Similarly, a person can listen to a speech pre-recorded on a particular medium, like an audiotape or a compact disk (CD), which can be played back, perhaps under variable speed control.

The listening process, however, is, by nature, a sequential scan of an audio stream. It requires the listener to listen to the information being transmitted in a linear manner, from a beginning of the text to an end, to obtain an overall understanding of the information being presented. Listeners cannot effectively browse or navigate through a textual document using some device interfacing with a tape or CD player, for example a human speech recognition or switch interface. Additionally, and most importantly, an audio signal comes from its source, which is fixed in space in one perceived direction.

The ability to precisely control the perceived direction of a sound has been described in U.S. Pat. No. 5,974,152, titled “SOUND IMAGE LOCALIZATION CONTROL DEVICE”. That patent describes how a sound image localization control device reproduces an acoustic signal on the basis of a plurality of simulated delay times and a plurality of simulated filtering characteristics as if a sound image ware located on an arbitrary position other than positions of separately arranged transducers.

Several patents describe various techniques for achieving such control, for example U.S. Pat. No. 5,974,152, and U.S. Pat. No. 5,771,041, titled “SYSTEM FOR PRODUCING DIRECTIONAL SOUND IN COMPUTER BASED VIRTUAL ENVIRONMENT”, which describes the sound associated with the sound source is then reproduced from a sound track at the determined level, to produce an output sound that creates a sense of place within the environment.

Another patent, U.S. Pat. No. 5,979,586, titled “VEHICLE COLLISION WARNING SYSTEM” describes a vehicle collision warning system that converts collision threat messages from a predictive collision sensor into intuitive sounds, which are perceived by the occupant of the vehicle, the sounds are directed from the direction of a potential or imminent collision.

Human beings live in a three-dimensional space and can benefit or take special advantage of auditory cues that emanate from different locations in that space.

### SUMMARY OF THE INVENTION

As the current technology lacks in any system or method for directing the delivery of auditory information to be perceived as coming from specific directions in the perceived auditory field based on a predetermined classification of the type of information that is being transmitted, and the ability to directionally navigate the information, thus increasing in difficulty and cost the ability to facilitate tasks, recognition, and recall, an object of the present invention is to substantially solve at least the above problems and/or disadvantages and to provide at least the advantages below.

Accordingly, an object of the present invention is to provide a system and method for presenting and browsing information, comprising the steps of classifying the information into a plurality of classes and sub-classes, each class having at least one sub-class; and presenting the plurality of classes of information to a user.

A further object of the present invention is to provide a system and method for presenting and browsing information, comprising the step of interactively controlling the presentation of the sub-classes.

### BRIEF DESCRIPTION OF THE DRAWINGS

The foregoing and other objects, aspects, and advantages of the present invention will be better understood from the following detailed description of preferred embodiments of the invention with reference to the accompanying drawings that include the following.

FIG. 1 is a diagram illustrating the concept of the system and method for presenting and browsing structured aural information.

FIG. 2 is a simplified block diagram of the inventive system.

FIG. 3 is a block diagram of the system for presenting and browsing structured aural information.

FIG. 4 is a flow diagram illustrating the operation of the system for presenting and browsing structured aural information according to an embodiment of the present invention.

FIG. 5 provides a simple example dialog between a user and the system.

FIG. 6 is a flow chart illustrating the control flow of the browsing manager.

### DETAILED DESCRIPTION OF THE PREFERRED EMBODIMENT

Several preferred embodiments of the present invention will now be described in detail herein below with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention describes a system that can present categorized audio information to specific locations in a listener's aural field and allows the listener to navigate through this directionally “tagged” or “annotated” information, attending to details in sections that may be of interest while skipping over others that are not. Using this inventive navigation system the listener can quickly assess the “nature” of the information, can hierarchically ascend or descend into sections to explore them in more detail, and can navigate through the information to review previously read sections or study them in greater detail.

One embodiment of the present invention presents categorized information perceived in different locations of the listener's aural field and allows navigation through speech or other interface devices. The listeners can easily navigate the presented information and can associate certain information as coming from a particular location thus aiding recall. The listeners can also index or ask for replay of the information by referring to the location where they perceived such information has originated. For example, when traveling in a car, news can come from the perceived left of the listener, while stock exchange notifications can come from the right. Navigation directions from an in-car navigation system may come from the rear, or even from the direction that the driver/listener is suppose to turn. For example, when a left turn is suggested the notification comes from the left of the driver/listener's perceived auditory field. The advantage of the present invention is that listeners can quickly browse and navigate information in a more “random access” or hierarchical manner, allowing the listeners to more quickly assess their interest, to focus on parts of the audio information that are relevant to them, and to be able to quickly navigate the information that they have explored to attend to information of interest.

Many existing documents and other information sources today are classified into sections and the content can be interpreted as being hierarchical. For example, word processing document files typically have an abstract, headings, and paragraph tags, which define a hierarchical structure of a given document. Hyper text markup language (HTML) files have a similar classification structure that can be interpreted as hierarchical. Document headings, for example, are hierarchical in nature and their label or associated text can be interpreted as a description of the content of the document. Content (any information that is to be presented) may be classified based on the source/origin of the content. For example, news may come from a “News Service”, stock quotes may come from a “Stock Service”, and email may come from a “Message Service”. The origin of the content may be enough of a classification to determine its presentation. The user, for example, may define a profile for the system that tags the content, which in turn determines where in the aural field the information is delivered. In the above examples, the different content is output from a different direction.

Hierarchical content such as technical papers that exist in a classification form (e.g. HTML or any mark up language format) can also be easily presented to the user based on a user-specified profile. The system could be delivered with a set of default locations for information delivery to facilitate easy use. The sections are tagged and sequentially mapped, based on the directional tagging, to appear to be coming from locations that are separated by 60 degrees in the users aural field. The tagging and mapping are arbitrary and definable by the user through a profile. It is possible to take any unstructured document, classify it according to its hierarchical structure using annotation systems, and then directionally tag the classifications. A “Section/Hierarchy” annotator “markups” the document with hierarchy classifications that could be used for presentation. The present invention then interprets this classification and assists the user in examining the document. Another Section/Hierarchy annotator could use many heuristics and could be a very complex text analysis component depending on the type of documents processed. It could use some simple heuristics, such as, looking for section numbers that often appear in technical documents. For example, these documents often have sections that are numbered and subsections have successive numberings. For example,
3
3.1
3.1.1
3.1.1.1
   illustrate one such scheme used. Some documents have section names or have text appearing in different fonts. For example,
Abstract
Introduction
Results
Discussion
Conclusion
Summary
   are often seen in documents. This could be incorporated in the “Section/Hierarchy” annotating algorithm for classifying and directionally tagging unstructured text. Other techniques could employ machine learning algorithms that would learn from documents classified by humans and could then use this knowledge to tag subsequent documents. Text Analysis has been an important field of research for many decades that has made much progress. One skilled in the art would be able to create a useful “Section/Hierarchy” annotator.

As can be seen, “classification” herein relates to the preset or user defined section or hierarchy of the input data, whereas “directional tagging” or “tagging” relates to how the system according to the present invention will direct the output of the data.

As another example, the first sentence of a paragraph is usually a topic sentence describing what will be elaborated in the following paragraph. The last sentence often makes the major point. So, by classifying this inherent hierarchy that exists in many documents, the present invention enables the listener or user to preview or skim the structure of a document by listening to just the abstract and the headings. The abstract or heading can be considered the top level of the hierarchy. The user can then “jump” to other levels, e.g. the “abstract”, “summary”, “conclusion” or the heading of interest, and examine the sub-headings in the section. Similarly, the user can examine the topic sentence (first sentence) of each paragraph of a terminal sub-heading for a quick overview of that section. Additionally, the user can listen to each sentence of the paragraph for the fine grain details.

Many existing documents have a structure that can be interpreted as hierarchical and can be used directly using such a system. However, it is also possible to annotate any information input into the system of the present invention with meta-information, for example related to hierarchy, meaning or category, to afford presentation, browsing and navigation, especially useful for the blind or those that can not afford to look at written text due to the task that they are performing. Information sources may also be used to create a category for a piece of information. For example, all information coming from a stock quote service falls into the category “stocks”, news originating from a news service may fall into the category “news”, etc. The classification of “stock” or “news” can then be used to directionally tag the information and direct the output of the information and control the browsing commands.

In addition and according to another embodiment of the present invention, the user can directly control the ability to classify and tag the information and access these classifications and tags, thus giving the user greater ability to navigate previously explored information. Extending the system to support annotation and editing provides a powerful tool for the generation of documents facilitating their reading, browsing, and reuse.

According to another embodiment of the present invention, to facilitate recall and browsing, in addition to the hierarchical information associated with specific locations in the aural field, for example, each specific heading label and associated sub information may be presented as coming from a unique direction in the aural field, navigation could then be performed by taking advantage of this association. For example, the document could be browsed by jumping to a specific “Heading” by, for example, a pointing gesture (interpreted by an associated gesture recognition system) to a specific location in space associated with where that information originated upon first listening; turning an indicator dial that points to that location; or using speech to go to that named location, e.g., 35 degrees left. Ascending and descending the hierarchy can be achieved by similar methods referring however to an orthogonal axis, e.g., up, down. Humans, especially the blind, have an exceptionally well-developed spatial auditory memory and will greatly benefit from the present invention as a powerful mechanism for textual “landmarking” and navigation.

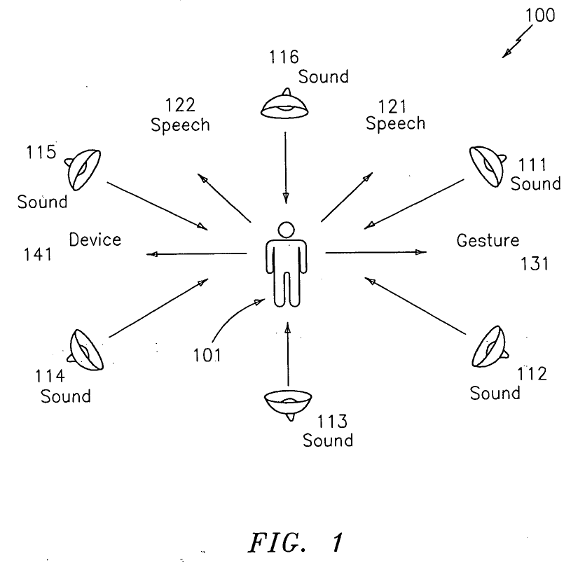

FIG. 1 is a diagram illustrating the concept of the system and method for presenting and browsing structured aural information. The system and method according to the preferred embodiment of the present invention will now be generally described with respect to FIG. 1. FIG. 1 illustrates the architecture of the components of an input and output (I/O) system 100 of the present invention. The general I/O system 100 is shown in FIG. 1. User 101 receives sounds from speakers 111 to 116. The sounds emanating from the speakers 111 to 116 have been directionally tagged by the invention and are output from a particular speaker based on the associated directional tag. The preferred embodiment of the present invention delivers auditory notifications (or other information) based on a predetermined or user determined classification scheme and directional tagging that directs the information to a particular perceived location in space. The directional tagging determines from which speaker particular information is output, in a process described in more detail below. A user 101 perceives the sound information and navigates through the information in any number of input means. Three particular input means are depicted in FIG. 1, namely, speech 121 and 122, gesture 131, and device 141.

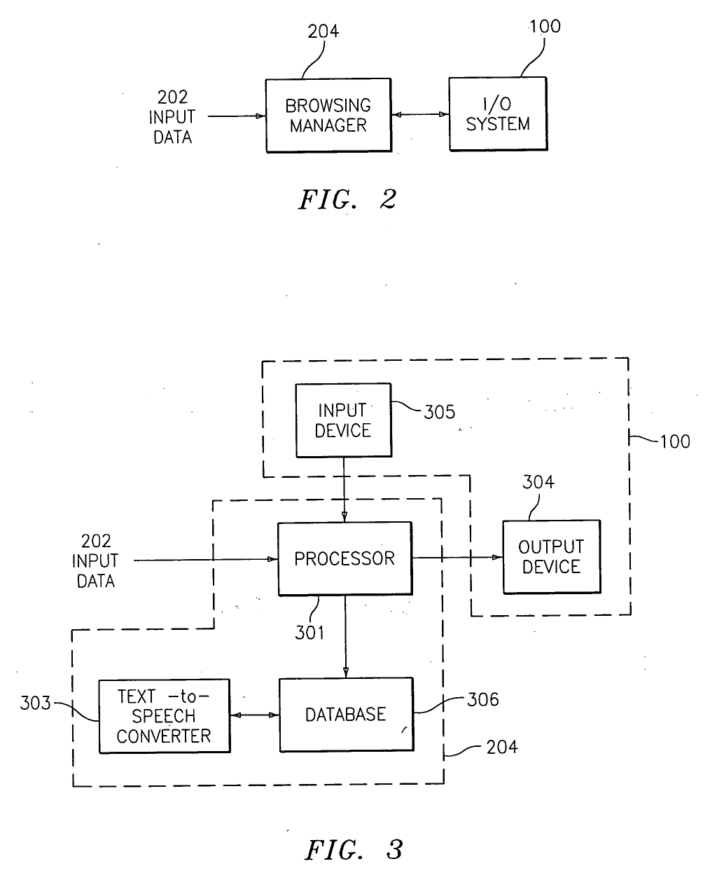

FIG. 2 is a simplified block diagram of the inventive system. Shown in FIG. 2 are input data 202, browsing manager (BM) 204, and I/O system 100. The input data can be any information capable of being classified and output as sound. The browsing manager 204 processes the input data, controls its directional output (i.e. directionally tags the data), and controls the user's navigation through an input system. The role of the BM 204 is to present tagged information to the user through sound that comes from different directions and allow the user to browse this information in a dynamic (not limited to a linear sequential) manner. The system processes three main functions: first, the system determines from which speaker to output the data and outputs the data accordingly; second, the system processes the navigational commands input by the user through the input system; and third, the system outputs the data navigated by the user.

FIG. 3 is a block diagram of the system for presenting and browsing structured aural information. Shown in FIG. 3 are I/O system 100, input data 202, and browsing manager 204. I/O system 100 is comprised of output system 304 and input device 305. Output system 304 has been previously described as speakers 111 to 116, but is not limited in number, that is, the minimum number of speakers for the system to operate is two, and the maximum number of speakers would be only limited to the level of distinction that the user 101 can perceive. Also, through the use of a known technique of combining outputs from more than one speaker, i.e. stereo, sound can be perceived as emanating from a place in space not directly associated with a speaker. Additionally, although the system in FIG. 1 is shown in the 2-dimensional realm, a 3-dimensional output system is also contemplated.

Input device 305 and the set of commands for navigation will now be described. Three input modalities will be elaborated: speech, electro/mechanical devices, and virtual reality gestures.

Speech is particularly useful in environments where the user is engaged in some other activity and does not have his hands free, such as when driving. Speech input systems are well known in the art. These speech input systems generally include a microphone for receiving the spoken words of a user, and a processor for analyzing the spoken words and performing a specific command or function based on the analysis. For example, many mobile telephones currently on the market are voice activated and will perform calling functions based on an input phrase, such as dialing a telephone number of a person stored in memory. The system according to the present invention can be programmed to respond to spoken degrees in the aural field. As shown in FIG. 1, if the system consists of six speakers, the aural field can be divided such that “0 degrees” (speaker 116), “60 degrees” (speaker 111), “120 degrees” (speaker 112), “180 degrees” (speaker 113), “240 degrees” (speaker 114) and “300 degrees” (speaker 115), can be recognized as spoken browsing commands. If the user says “60 degrees” the system will play the data associated with speaker 111. Variations on this concept are contemplated.

Input devices are also contemplated as electro/mechanical devices that may include dials, buttons or graphical user interface devices (e.g. a computer mouse, etc . . . ) These electro/mechanical or standard computer input devices are quite common, and are all contemplated herein. By turning a dial to point in a predefined direction, or moving a joystick to point in a predefined direction, the system can navigate the information accordingly.

A third input device that is contemplated is a virtual reality input device. The virtual reality input device of the preferred embodiment is a device that will recognize the direction that a user is pointing and translate that direction into a command. The industry is replete with devices that can recognize a hand gesture of a user, whether that device is a user-worn glove, finger contacts, or an external recognition system. Whichever virtual reality input device is used, the object is to translate the direction of the user's gesture into a browsing command through the browsing manager 204.

Returning again to FIG. 3, the browsing manager 204 will now be described. The browsing manager 204 is comprised of three main components, namely, a processor for controlling the overall operation of the system, a text-to-speech converter 303 for converting text-to-speech, and a database 303 for storing the translated text-to-speech data. Not shown in FIG. 3, but part of the system, is a memory for storing the operating programs of the system, namely the particular algorithms that will classify and tag the text according to a preset or user defined process, output the text as speech into the aural field of the user from predetermined or user defined directions, and control the browsing through the text as controlled by the user through input device 305.

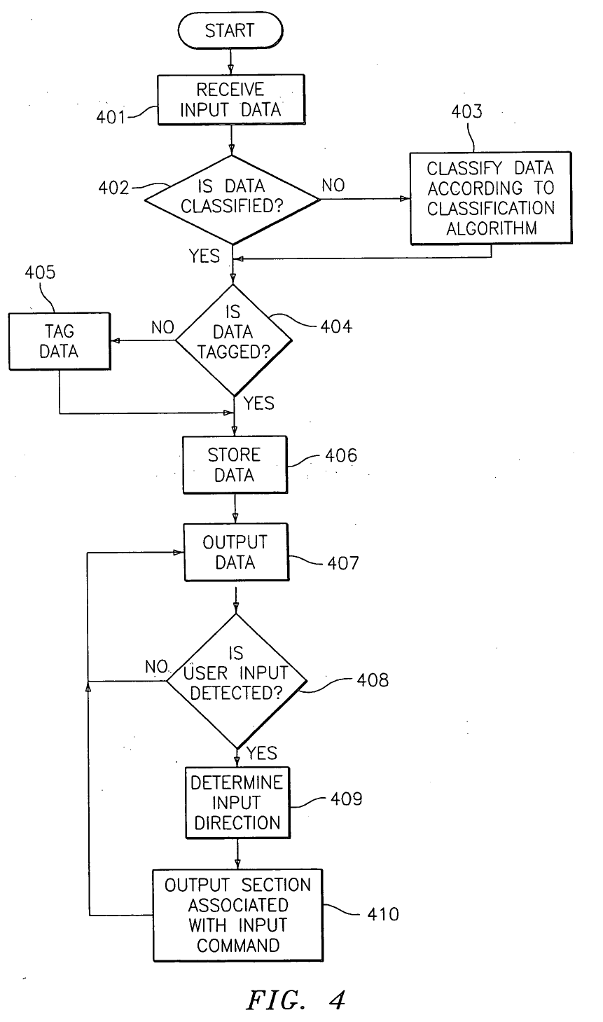

FIG. 4 is a flow diagram illustrating the operation of the system for presenting and browsing structured aural information according to an embodiment of the present invention. The general operation of the system will now be described with respect to FIG. 4. In step 401 the input data is received. In step 402 it is determined if the input data is classified. If it is determined in step 402 that the data is not classified, the system processes in step 403 the data using a preset or user defined content classification system. Next, in step 404 the system determines if the data is tagged. If the data is not tagged, the system in step 405 tags the data according to a preset of user defined tagging scheme. The classified and tagged data from either step 404 or 405 is then stored in a database in step 406. The system, either immediately upon storing of the data or upon a start command of the user, begins to output in step 407 the tagged data. The data is output from particular directions based on the output algorithms. In the car example, news is output from the left, stock information is output from the right, and driving directions are output from the front. Or in the technical paper example, section 1 output from 0 degrees (i.e. speaker 116), section 2 from 60 degrees (i.e. speaker 111), etc. . . . After the section titles are output, the system can be programmed to begin reading section 1 or pause to await user input. The system then determines in step 408 if a user browsing command is input. If no browsing command is input, the system continues to process step 407 to continue delivery of the data. If the system determines in step 408 that a user browsing command is input, the system continues to step 409 to process the command. In step 409 the browsing command is determined, that is, if the speech system is used, and the user inputs, for example “60 degrees”, the system determines that the user desires to hear section 2. In step 410 the system begins playback of section 2, and returns to step 407. Of course, system control commands such as “stop” or “pause” (tailored to any of the input modes) can be incorporated into the system for basic control of the output.

In the above example where the user desires to hear section 2, it is possible that section 2 has been sub-tagged into further sections or categories as discussed above, the system can be programmed to output the section 2 classifications or playback of the section itself. These sub-processes can be preset or user defined, and can also be controlled by particular user input. For example, the user can have the option to input several commands based on the directional output, such as, “read 60 degrees” or “highlight 60 degrees”. If “read 60 degrees” is input the system would begin full playback of section 2, but if “highlight 60 degrees” is input the system would playback the section headings of section 2. The classification and tagging of the data, and range of input commands, are only limited to system design and resources.

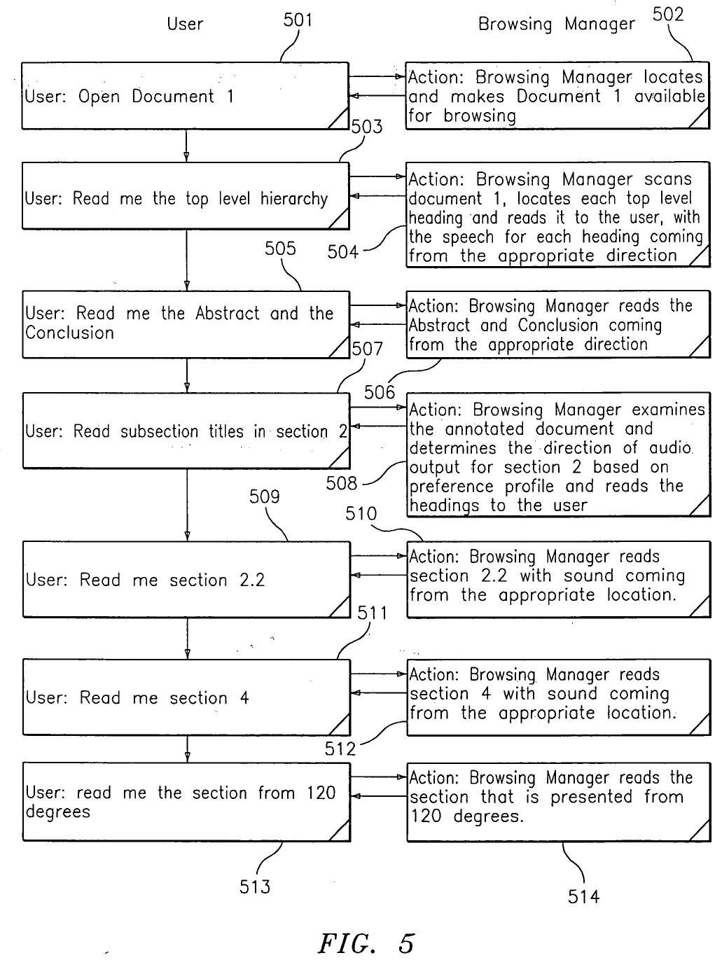

FIG. 5 provides a simple example dialog between a user and the system. Throughout the example of FIG. 5, the speech input mode is shown, but other input modes are contemplated. In step 501 the user states, “open document 1”. In step 502 the browsing manager takes the action of locating and providing document 1 to the user. In step 503 the user states, “read me top level hierarchy”. In response thereto, the browsing manager in step 504 scans document 1, locates each top-level heading and outputs the top-level headings from the appropriate directions as directionally tagged. In step 505 the user states, “read me the abstract and the conclusion”. The browsing manager in step 506 outputs the abstract and conclusion from the appropriate direction as directionally tagged. In user in step 507 states, “read subsection titles in section 2”. In response thereto, the browsing manager in step 508 examines the classified document and determines the direction of audio output for section 2 based on the preset or user defined classification and directional tags. In step 509 the user states, “read me section 2.2”. The browsing manager in step 510 outputs section 2.2 from the appropriate direction as directionally tagged. In user in step 511 states, “read section 4”. In step 512 the browsing manager outputs section 4 from the appropriate directions as directionally tagged. In step 513 the user states, “read me the section from 120 degrees”. In response thereto, the browsing manager in step 514 outputs the section that was presented from 120 degrees. The process continues as above until the user is finished.

The example illustrated in FIG. 5 uses only the speech input mode. The system can be adapted to use more than one input mode at a time. For example, in addition to the speech input mode of FIG. 5, the virtual reality input mode can be combined to produce a hybrid process. For example, in step 508 if the browsing manager outputs the headings of section 2 such that heading 2.1 outputs from speaker 116 at 0 degrees, and heading 2.2 outputs from speaker 111 at 60 degrees, the user can point to 60 degrees in his aural environment (essentially pointing to speaker 111, but noting that the reference point does not have to be tied to the system but can be based on the user himself, and of course can be user defined), the browsing manager would output section 2.2. In this manner the user can access and navigate the data based merely on pointing in a particular direction.

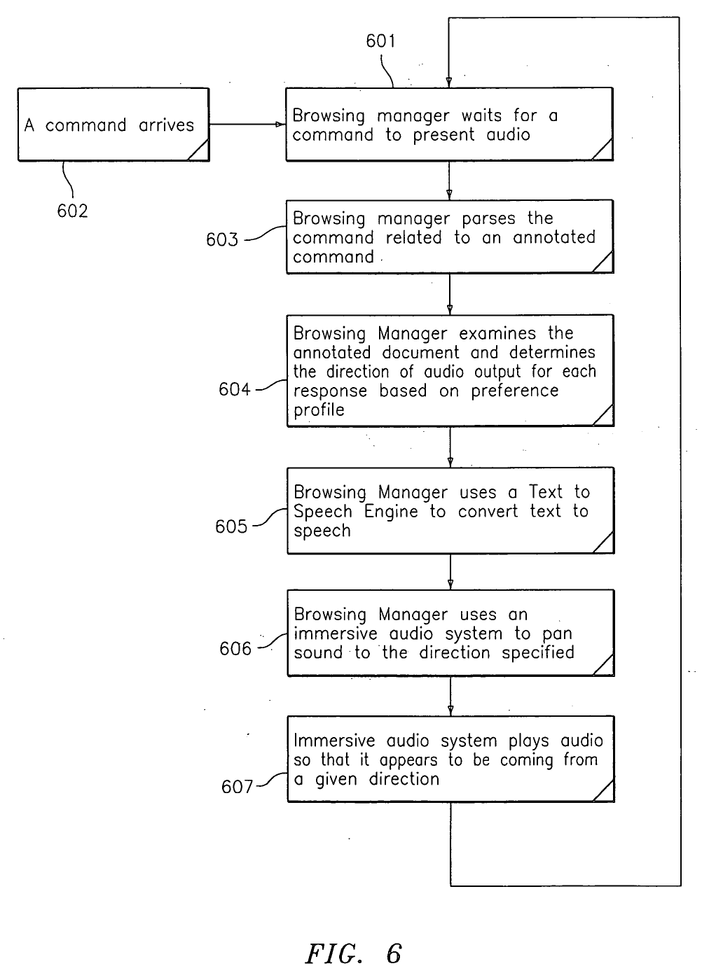

FIG. 6 is a flow chart illustrating the control flow of the browsing manager. In step 601, the browsing manager awaits a user input command. When a user command is input in step 602, the browsing manager in step 603 parses the command. In step 604 the browsing manager examines the document and determines the output direction of each response. In step 605 the browsing manager converts the data to speech using a speech conversion program. In step 606 the browsing manager assigns the speech to the appropriate directions according to the directional tags. In step 607 the system outputs the sound from the appropriate directions.

While the invention has been shown and described with reference to certain preferred embodiments thereof, it will be understood by those skilled in the art that various changes in form and details may be made therein without departing from the spirit and scope of the invention as defined by the appended claims.

1. A method for presenting and browsing information, comprising the steps of:
classifying the information into a plurality of classes and sub-classes, each class having at least one sub-class; and
presenting the plurality of classes of information to a user.

2. The method of claim 1, further comprising the step of interactively controlling the presentation of the sub-classes.

3. The method of claim 2, further comprising the step of directional tagging said classified information for spatial presentation,
wherein each class is audibly presented from a different position in space based on the directional tagging.

4. The method of claim 3, wherein the interactively controlling step includes the steps of:
receiving an input command from the user, said input command containing information identifying a position in space from which a class was presented; and
presenting sub-class information of the class said input command identified.

5. The method of claim 4, wherein the input command is received through a spoken command from the user.

6. The method of claim 4, wherein the input command is received through an input device having means for determining a direction to which a user points.

7. The method of claim 4, wherein the input command is received through an electrical or mechanical input device.

8. The method of claim 2, wherein the interactively controlling step includes the steps of:
receiving an input command from the user, said input command containing information identifying a class or sub-class; and
presenting further information of the class or sub-class said input command identified.

9. A system for presenting and browsing information, comprising:
a processor for classifying the information into a plurality of classes and sub-classes, each class having at least one sub-class; and
an output system for presenting the plurality of classes of information to a user.

10. The system of claim 9, further comprising an input system for interactively controlling the presentation of the sub-classes.

11. The system of claim 10, wherein said processor directional tagging said classified information for spatial presentation, and each class is audibly presented through said output system from a different position in space based on the directional tagging.

12. The system of claim 11, wherein said processor receives an input command from the user through said input system, said input command containing information identifying a position in space from which a class was presented, and presents sub-class information of the class said input command identified.

13. The system of claim 12, wherein said input system is a speech recognition system.

14. The system of claim 12, wherein said input system is an input device having means for determining a direction to which a user points.

15. The system of claim 12, wherein said input system is an electrical or mechanical input device.

16. The system of claim 10, wherein the processor receives an input command from the user through the input system, said input command containing information identifying a class or sub-class, and presents through said output system further information of the class or sub-class said input command identified.

17. The system of claim 9, wherein the output system is at least two speakers.

18. A computer program device readable by a machine, tangibly embodying a program of instructions executable by the machine to perform method steps for classifying the information into a plurality of classes and sub-classes, each class having at least one sub-class, and presenting the plurality of classes of information to a user.

19. The computer program device readable by a machine, tangibly embodying a program of instructions executable by the machine of claim 18, to further perform a step for interactively controlling the presentation of the sub-classes.

20. The computer program device readable by a machine, tangibly embodying a program of instructions executable by the machine of claim 19, to further perform a step for directional tagging said classified information for spatial presentation,
wherein each class is audibly presented from a different position in space based on the directional tagging.

21. The computer program device readable by a machine, tangibly embodying a program of instructions executable by the machine of claim 20, to further perform a step for receiving an input command from the user, said input command containing information identifying a position in space from which a class was presented, and presenting sub-class information of the class said input command identified.

22. The computer program device readable by a machine, tangibly embodying a program of instructions executable by the machine of claim 21, wherein the input command is received through a spoken command from the user.

23. The computer program device readable by a machine, tangibly embodying a program of instructions executable by the machine of claim 21, wherein the input command is received through an input device having means for determining a direction to which a user points.

24. The computer program device readable by a machine, tangibly embodying a program of instructions executable by the machine of claim 21, wherein the input command is received through an electrical or mechanical input device.

25. The computer program device readable by a machine, tangibly embodying a program of instructions executable by the machine of claim 19, to further perform a step for receiving an input command from the user, said input command containing information identifying a class or sub-class, and presenting further information of the class or sub-class said input command identified.

26. The method of claim 4, wherein the input command is received through at least one of a speech recognition system, an input device having means for determining a direction to which a user points, and a standard computer input device.
